(19) United States
(12) Patent Application Publication
(10) Pub. No.: US 2011/0136985 A1
(43) Pub. Date: Jun. 9, 2011

(54) MOLDED ARTICLE HAVING A MOLD IMPARTED RELEASE LAYER COATING

(76) Inventors: Douglas E. Moon, Loveland, OH (US); Alan C. Kilbarger, Milford, OH (US); Chad Michael Forsthoefel, Lebanon, OH (US)

(21) Appl. No.: 12/902,439

(22) Filed: Oct. 12, 2010

Related U.S. Application Data
(60) Provisional application No. 61/285,053, filed on Dec. 9, 2009.

(51) Int. Cl. C08F 214/18; B28B 7/36

(52) U.S. Cl. 525/326.2; 264/338

(57) ABSTRACT

A process for molding an article is provided that includes applying a permanent release coating to a surface of a mold cavity. The permanent release coating is over layered with a top coat that upon filling the mold cavity with a polymer or a polymer precursor under conditions to form the article, the top coat is transferred to the resultant article to form a top coat skin without appreciably removing the permanent release coating from the surface of the mold cavity. Articles having curved surfaces and high aspect ratios are particularly well suited for forming a top coat skin thereon through the process. An unsaturated top coat material is noted to react with the polymer or polymer precursor during molding to form a top coat skin that is covalently bonded to the remainder of the article. The process detailed herein is particularly well suited for forming covalently bonded coatings on elastomeric articles. The top coat skin provides a lower coefficient of friction, modified hydrophobicity, resistance to attack by solvents and other chemical agents, as well as blocking resistance changes relative to the base article absent the top coat. A benefit of the present invention is that post-molding application of a comparable top coat is thereby avoided.

### CROSS-REFERENCE TO RELATED APPLICATION

This application claims priority of U.S. Provisional Patent Application Ser. No. 61/285,053 filed Dec. 9, 2009, which is incorporated herein by reference.

### FIELD OF THE INVENTION

The present invention in general relates to a molded article having an in-mold applied functional top coat, and in particular to a molding process that includes a mold having a base coat to which various top coat materials are applied with the top coat being transferred to the molded article.

### BACKGROUND OF THE INVENTION

A molded article is produced by forming a negative cavity in a mold that corresponds to the desired shape of an article. Dimensional changes relative to the mold are common based upon the coefficient of linear thermal expansion for the material from which the article is formed. This change in dimensionality of a molded article with temperature change often creates problems associated with demolding the article from the mold. Also, often an article has an unacceptable degree of adhesion to the mold surface that decreases throughput and often requires mechanical extraction of an article from a mold that can lead to article damage. In response to these and other practical problems associated with article molding, it is common practice to coat a mold to provide lubrication, thermal protection, release and other properties that facilitate mold longevity and throughput.

There are various types of release agents that are employed to facilitate removal of the molded article. The following lists various types of mold release agents although no limitation is placed on this invention with regard to them. These materials can be applied to the mold in any fashion which facilitates the removal of the molded article. These materials are often applied utilizing apparatus that atomize the release agent thereby imparting the deposition of a film or amount of the release agent which facilitates the removal of the molded article. Pump bottles, pressurized can/nozzle apparatus, externally atomized sprayers, internally atomized sprayers, HVLP, and high pressure airless sprayers are exemplary of suitable equipment for the application of a mold release agent.

The release agents referred to above may also be applied utilizing a brush or cloth (rag) which is wetted with the release agent. This method is less preferred particularly for heated molds as the release agent tends to dry on the applicator. Mold release agents may also be applied by dipping the mold (form) in the release agent. The molding of composite golf shafts and fishing rods are often formed after the release agent is applied by dipping the form (mandrel) which is utilized to form the inner diameter of the molded article.

There are the so-called sacrificial release agents. These materials are typically applied to the mold for each and every round of molding. These materials are of various base compositions and include, but are in no way limited to, those based upon silicon, fluorine, hydrocarbon, polyethers, and the like. These materials typically function by imparting a film or interface between the mold and the molding medium. This type of release agent typically fails by transferring to the part thereby preventing adhesion of the article to the mold.

There are the so-called semi-permanent release agents, These materials are not typically applied to the mold for each and every round of molding. These materials are applied to the mold on an interval which is suitable for the particular molding process. These materials form an interface on the mold which prevents the medium from adhering to the mold. There can be some transfer of the semi-permanent release agent without removal of the release agent from the mold surface. Again, no limitation is placed upon this invention by the above description.

There are the so-called permanent release agents. These materials can be based upon various chemistries including those based upon silicon, fluorine, hydrocarbon (organic) and combinations of the above. Permanent release coatings are often based upon fluorine chemistries and include but are not limited to those based upon polytetrafluoroethylene (PTFE), fluorinated ethylene-propylene (FEP), perfluoroalkoxy polymer resin (PFA) and the like.

The various types of release agents described above can be utilized for the release of molded articles by themselves or in combination with each other. The examples below are typical to the formation of molded articles although are no way limiting with regard to this invention.

Semi-permanent release agent utilized as a base coat in combination with a sacrificial release agent applied either every round or on an interval of rounds. Molded articles such as stoppers intended for the sealing of vials are often compression molded utilizing this combination of release agents.

Permanent release agent in combination with a sacrificial release agent. Golf ball cores based upon polybutadiene elastomer are often molded utilizing this combination of release agents.

Permanent release agent in combination with a semi-permanent release agent. Golf ball cores are often molded utilizing this combination of release agents.

There are also the so-called in mold coatings which are applied over the above coatings either by themselves or in combination with each other. Molded articles of urethane foams or elastomers are often painted utilizing an in mold paint painting process. In mold painted steering wheels are a primary example.

By way of a tutorial as to how release agents are used in various types of molding, a summary of various types of article molding follows.

Thermoplastic injection molding involved the use of a thermoplastic material and a mold which is chilled below the solidifying temperature of the thermoplastic material. The thermoplastic material is heated above its melting point in a separate chamber and subsequently injected into the mold. The temperature of the mold causes immediate solidification of the thermoplastic material which typically provides for release of the thermoplastic material from the mold. The use of release agents in such processes is typically not required although there are processes which do in fact require the use of a release agent.

Die cast molding is in many ways similar to thermoplastic injection molding. The mold (or die) is chilled so as to be much lower than the melt point of a relatively low melt point metallic material (aluminum and magnesium being the primary molding media). Die cast molding typically requires the use of a release agent referred to as a die cast lubricant. The die cast lubricant provides for release of the part as well as providing for a chilling capacity for the mold.

Reaction injection molding involves the use of materials that react with each other at low, ambient or elevated temperatures. A primary example of a molding medium is the use of a diisocyanate and a curing polyol and/or amine utilized to form a foamed or elastomeric polyurethane molded article. Examples include (but are in no way limited to) carpet underlayments, armrests, steering wheels, instrument panels, filter housings, and encapsulated glass. The molds utilized in such applications are in general much above ambient. The mold temperatures for foamed urethane articles can range from about 100° F. to about 170° F. Release agents utilized in the formation of foamed urethane articles are in general applied for each and every round of molding and can be of various base compositions which are obvious to those of ordinary skill in the art.

Open cast molding involves the use of a reactive resin media at ambient or elevated temperatures. Examples of media include (but are in no way limited to) epoxy resins which are cured with amino functional resins or other curative (including polyamides) and acid anhydride systems typically in the presence of a catalyst. Examples include epoxy potting molded articles typically utilized in the electronics industry and the formation of so-called epoxy composite parts including sinks and countertops typically utilized in laboratories or hospitals.

Elastomeric materials referred to as rubbers can be molded utilizing compression molding. The molds are heated to a temperature which is at or above a temperature which causes the elastomer to cure. Curing a material is often referred to as vulcanization wherein a curative is utilized which causes the elastomer to crosslink thereby rendering a molded article which is suitable for the intended end use.

Examples of elastomers that are compression molding (without inducing any type of limitation) include elastomers based upon natural rubber (polyisoprene obtained from Hevea trees), terpolymers of ethylene, propylene, and a diene curative (EPDM) cured via either a sulfur or a peroxide. Other elastomers include (but in no way are limited to) those based upon acrylics, blends of isobutylene in combination with isoprene (butyl), silicon based elastomers as well as those based upon fluorine. This list is obviously not totally inclusive and is obvious to those of ordinary skill in the art.

Compression molded articles typically require the use of a mold release agent which allows for removal of the molded article from the mold.

Elastomers may also be molded utilizing the process referred to as transfer molding. Transfer molding involves the use of a heated hopper which generally is of such volume to heat and confine a sufficient amount of elastomer for one or more round of molding. All or part of the contents of the hopper are plunged into the mold via an injection port into the cavity below. The elastomers cited above can typically be molding utilizing this technique. No limitation is placed upon the type of elastomer that is transfer molded. Articles produced utilizing the transfer molding process typically require the use of a mold release agent which allows for the release of the part from the mold.

The above-cited elastomers can also be molded utilizing a technique referred to as injection molding. This process involves the use of a geometrically extruded or calendered form of elastomer that is fed into a barrel wherein the elastomer is heated, mixed and plunged into the mold so as to form the intended article.

Other forms of molding include pultrusion, molding around a form and causing cure by heating in an oven or autoclave (in the case of composite molding of, for instance, golf shafts or fishing rods).

In spite of the considerable efforts with respect to polymeric molding, it remains that a mold having a release agent coating permanently affixed to the mold does not exist that is capable of transferring a coating to a molded article that represents the positive of the mold cavity. Thus, there exists a need for a process by which a mold release coating is transferred from another mold release agent interface to provide an improvement in the physical characteristics of the resultant article formed from the mold.

### SUMMARY OF THE INVENTION

A process for molding an article is provided that includes applying a permanent release coating to a surface of a mold cavity that may need to be cured before operative. The permanent release coating is over layered with a top coat (release agent) that upon filling the mold cavity with a polymer or a polymer precursor under conditions to form the article, the top coat is transferred to the resultant article to form a top coat skin without appreciably removing the permanent release coating from the surface of the mold cavity. Articles having curved surfaces and high aspect ratios are particularly well suited for forming a top coat skin thereon through the process. An ethylenically unsaturated hydrocarbon-based or a hydride functional silicon top coat material is noted to react with an unsaturated elastomer or polymer precursor during molding to form a top coat skin that is covalently bonded to the remainder of the article. The process detailed herein is particularly well suited for forming covalently bonded coatings on elastomeric articles. The top coat skin can provide for lower coefficient of friction, modified hydrophobicity, resistance to attack by solvents and other chemical agents, as well as blocking resistance changes relative to the base article absent the top coat. A benefit of the present invention is that post molding operations of cleaning the sacrificial release agent from the surface, and then recoating the article and subsequently baking the article to cure the coating are avoided.

### DETAILED DESCRIPTION OF THE PREFERRED EMBODIMENTS

The present invention has utility as a process for molding an article from a polymer or polymer precursor to simultaneously impart a top coat skin to the molded article.

According to the present invention, the workable lifetime of a mold is extended through application of a permanent release coating to a surface of the mold cavity while, at the same time, the permanent release coating readily transfers an overlaid top coat to polymer or polymer precursor filling the mold cavity. As a result, while mold lifetime is extended, the post-molding step of applying a similar top coat is avoided. As used herein, a top coat or top coat skin is used with respect to the material overlaying the permanent release coating or after adherence to a molded article, respectively. Preferably, the top coat lacks a pigment or other particulate that can dislodge from an embedding top coat skin matrix.

The novelty of the present invention provides for an article such as a stopper which has a non-extractable, siliconized, fluorinized or other top-coated skin. The molder realizes benefits by use of the invention including elimination of the cleaning step utilized to remove transferred, non-bonded sacrificial release agent, elimination of the step to apply a siliconizing, fluorinating or other coating, and elimination of the step to cure the siliconizing, fluorinating or other type of coating. The release coating top coats of this invention are coated more evenly to the blood vial surface and better adhered than siliconizing, fluorinating or other coatings that are applied post-molding and are significantly more difficult to extract from said surface thus better protecting the medicament from the surface of the stopper and the surface of the stopper from the medicament.

With respect to a permanent release coating as used herein, this is generally defined as being suitable for molding more than 40 rounds or more articles before such a coating needs to be reapplied. It is appreciated that 400 or more and even more than 2000 articles are formed before reapplication of the permanent release coating is required. In this context, a top coat skin formed on an article without appreciably removing the permanent release coating similarly indicates that more than 40 rounds of top coat can be applied and used to form a top coat skin on an article without requiring a replenishment or reapplication of the permanent release coating. The top coat also tends to ensure the integrity of the permanent release coating.

A permanent release coating used in the present invention provides ease of release of a top coat material therefrom and is resistant to degradation or dissolution by the top coat material. The top coat transfers from the permanent release coating interface to the molded article thereby facilitating release from the mold cavity and providing a top coat skin to the resultant molded article that also improves molded article properties relative to an article lacking such a top coat skin.

With respect to elastomeric stoppers for vials that are conventionally molded using a combination of base coat along with a sacrificial, highly diluted release agent which transfers to the resultant molded vial stopper, while the transfer imparts antiblocking properties to the molded stopper, the sacrificial release agent is migratory and not covalently or otherwise bound to the surface of the stopper, raising the prospect of possible contamination of the vial contents therewith.

According to the present invention, a permanent release coating is applied to a surface of the mold cavity. This permanent release coating forms a durable base coating on a surface of the mold cavity. It is appreciated that such a base coat is itself formed as a single layer of material applied to a surface of the mold cavity or includes multiple layers of like or differing material sequentially applied to build up a permanent release coating base coat. An aspect of this base coat is that it provide for release of an over layered top coat to a molding polymer or polymer precursor that will fill the mold cavity. Permanent release coatings operative to form a base coat according to the present invention include polymers that are neat, solvent based, and water based materials. A permanent release coating is readily formed in situ upon application to a surface of the mold cavity through common cure techniques such as ultraviolet cure, free radical cure, acid cure, and anaerobic cure. In instances when a permanent release coating forms a base coat from a solution or dispersion, non-VOC solvents are preferred over VOC solvents for environment reasons; and more preferably, a base coat contains as part of the solvent system water. By way of example, a mixed water-solvent system is preferred over a purely organic solvent-based system. It is further appreciated that mixed organic solvent-water solvent systems for a permanent release coating base coat optionally include a surfactant to facilitate miscibility between the water and organic solvent components. Solvent-free and in particular volatile organic compound (VOC)-free systems are preferred and illustratively include water-based permanent release coating systems, neat permanent release coating polymers or precursors (solvent free and water free), as well as powder coating systems that form a permanent release coating.

A permanent release coating base coat according to the present invention can include compositionally different substances and is limited only by the requirements that a top coat skin on the resultant molded article formed from a top coat precursor overlaid onto the permanent release coating, and that the permanent release coating survive at least 40 molding cycles to form molded articles. Representative permanent release coatings according to the present invention illustratively include organic-based materials such as epoxies, modified epoxies, PEEK, and the like, fluoropolymer analogs thereof, and perfluoro analogs thereof; silicon-based coatings such as those based on curable silicon resins precursors, fluoropolymer analogs thereof, and perfluoro polymer analogs thereof; and combinations of any of the aforementioned materials.

According to the present invention, upon forming a cured permanent release coating on a surface of the mold cavity, this permanent release coating is over layered with a top coat precursor. The top coat precursor during the molding process covalently bonds to the molded article formed within the mold cavity and forms a top coat skin on the article. The top coat skin allows the permanent release coating to generate at least 40 molded articles with intermediate overlaying by a top coat precursor and mold fill with a polymer or polymer precursor. An inventive top coat precursor has the same attributes as the permanent release coating in terms of application in neat form from organic solvent or water-based solvent, or a mixed water-organic solvent system. Additionally, a top coat precursor is chosen from the same list of materials as the permanent release coating base coat with the proviso that the top coat precursor upon covalent bonding and forming a top coat skin on a molded article releases from the adjacent permanent release coating.

In order to practice the present invention, a mold for an article is degreased and otherwise cleaned and then a permanent release coating is applied to a surface of the mold cavity as detailed above. Upon cure of the permanent release coating to form a base coat, the top coat precursor is overlaid onto the permanent release coating and the mold cavity is then filled with a polymer or polymer precursor through any number of conventional molding techniques under conditions to form the article and to transfer the top coat to the article and thereby form a covalently bonded top coat skin on the article without appreciably removing the permanent release coating from the surface of the mold cavity.

An inventive process is particularly well suited to the formation of molded articles having three-dimensional shapes distant from large planar sheets. Articles that have at least one nonlinear surface are exemplary of complex three-dimensional shaped articles that greatly benefit from an inventive process. Such articles have an aspect ratio in the orthogonal direction to the largest area plane of the article to the maximal linear extent in the largest area plane of the article that is between 0.1 and 0.9:1. In articles with such an aspect ratio, mold release and application of a top coat after molding present additional difficulties. Representative of such articles is a vial stopper characterized by a generally cylindrical shaped width that extends to a shoulder with a top wall extending from the shoulder. Such a vial stopper is routinely used in evacuated blood draw vials.

The present invention is further detailed with respect to the following nonlimiting comparative and inventive examples. These examples are not intended to limit the scope of the appended claims.

### Example 1

A durable, silicon-based permanent release coating formed by blending a methylsilsesquioxne resin solution and a polydimethyl siloxane containing hydroxyl terminated polydimethyl siloxane is applied to a clean stainless steel mold held at 180° C. utilizing a spray gun that produces a finely atomized spray. The permanent release coating is applied utilizing four applications each applied from a different direction so as to totally seal the clean mold. Each applied layer of base is allowed to cure for 1 minute between passes and 10 minutes after the last prior to the commencement of molding.

An aqueous, silicon based, top coat precursor which is an emulsion of a silicon based resin system which includes a blend of an unsaturated silsesquioxane and a polydimethyl siloxane polymer which is terminated with an unsaturated “silane” is applied to the hot (180° C.) mold which has been base coated as a spray to form a continuous layer to the unaided normal human eye. A halobutyl elastomer is loaded into the mold whereupon compression is applied for a total of 5 minutes. The unsaturated material present in the top coat precursor transfers to the halobutyl material and crosslinks with it to form a covalently bonded siliconized surface top coat skin on the molded stopper that is impervious to removal.

### Example 2

A fluorine based, permanent release coating of tetrafluoroethylene, hexafluoropropylene copolymeric dispersion (FEP) containing glycidoxypropyl silsesquioxane is applied to a clean tool as in Example 1 such that 4-6 mils of wet coating is applied to the tool surface as measured by a wet film thickness gauge. The coated tool is allowed to dry completely and subsequently baked such that a peak melt temperature of 370° C. is obtained for a minimum of 30 minutes. The tool is allowed to cool to room temperature. The tool is subsequently placed in a press and heated to 180° C. The same top coat is applied per Example 1 to the tool utilizing a spray gun which produces a finely atomized spray droplet. Halobutyl elastomer is introduced into the mold cavity and compression molded as cited above to produce a siliconized skin on the blood vial stopper which is impervious to attack by water and/or other medicaments.

### Example 3

The tool with the permanent release coating of Example 2 is heated in a press to 180° C. An aqueous, fluoropolymeric top coat of terpolymer of tetrafluoroethylene, hexafluorpropylene and vinylidene difluoride, which melts below 360° F., is applied utilizing a spray gun which produces a finely atomized spray droplet to the tool. Halobutyl elastomer is introduced to the mold cavity whereupon compression is applied for 5 minutes. A blood vial stopper with a fluorinated skin is produced.

### Example 4

The blood vial stoppers of the preceding examples are removed easily from the mold in each case. The stoppers were subsequently deflashed and subjected to the following extraction method.
1. A glass container is filled with 10 mL of deionized water.
2. A deflashed blood vial stopper is inserted into the container containing the 10 mL of deionized water.
3. The container is then capped, sealed and placed in a 110° C. oven for a period of one hour.
4. The bottle is allowed to cool to room temperature.
5. The deionized water is pipetted in small portions (approximately 0.50 grams) onto a silver bromide cell.
6. Each aliquot is baked dry at 110° C.
7. Steps 5 and 6 are repeated until all 10 mL from the glass container is applied and dried.
8. FITR (Fourier Transform Infrared Analysis) is then performed on the silver bromide cell produced above.

### Example 5

A copolymer of a dimethyl siloxane polymer with a methyl hydrogen functional siloxane polymer is prepared utilizing equilibration techniques which are well known to those of ordinary skill in the art. The polymer is emulsified utilizing a non-ionic surfactant system and deionized water. The emulsion is reduced with deionized water to 1.5% solids and applied to a blood vial stopper mold which has been previously coated with the permanent release coating of Example 2 and heated to 180° C. Halobutyl elastomer is introduced into the mold and blood vial stoppers are formed by compression molding. The blood vial stoppers are easily removed from the mold. The process is repeated four subsequent times with the 1.5% solids emulsion being applied between each round of molding.

The blood vial stoppers are defiashed and subjected to the same extraction method as described in Example 4. Subsequent concentration of the extract onto silver bromide cells is performed and analysis is performed by FTIR analysis. There is no indication of removal of the emulsion from the surface of the blood vial stopper in any case.

### Example 6—Comparative Example

An emulsion of a 350 centistoke poly dimethyl siloxane is diluted to 1.5% solids using deionized water and applied via air atomized spray gun over the top of a hot (180° C.) tool that had been basecoated with the permanent release coating of Example 1 above. Halobutyl elastomer is introduced into the mold cavity and compression molded as cited above to produce a blood vial stopper that has a non-bonded (non-adherent), siliconized skin. The blood vial stopper is deflashed and subjected to the deionized extraction as cited above (held for one hour at 110° C. in a glass container containing 10 mL of deionized water). The bottle is allowed to cool to 20° C. and the water extract concentrated onto a silver bromide cell per Example 4. FTIR analysis of the extract indicates an extensive amount of extracted polydimethyl siloxane that has been removed from the blood vial stopper surface. This removal indicates a lack of covalent bonding between the 350 centistoke dimethyl siloxane material and the blood vial surface thereby creating a serious potential for contamination of any medicaments that would be present in a vial that was overlayered with a vial stopper prepared as in this example. The transferred, 350 centistoke, polydimethyl siloxane also prevents adhesion of an applied siliconizing agent, a fluorinating agent or virtually any other type of coating to the surface of the vial stopper and must be removed prior to application of such coating materials. Removal of dimethyl siloxane material typically involves the use of a cabinet which is filled with detergent or a solvent degreasing material in order to remove the transferred material. The cleaned stoppers are subsequently coated with a coating such as a siliconizing agent, a fluorinating agent or other coating and typically cured in a variety of manners so as to dry and crosslink the coating such that the contents of the vial are protected from contamination by the surface of the blood vial stopper and the stopper is protected from attack by the medicament. The adhesion of a siliconizing agent, a fluorinating agent or other type of protective coating applied in this fashion is inferior to the “top coats” as described in the examples and following claims. Such “post” applied siliconizing agents, fluorinating agents, or other protective coatings are more likely to be extractable from the surface of the blood vial stopper by hot water and/or medicaments due to a lack of chemical bonding to the surface of the previously vulcanized substrate. There is evidence of extraction of this “siliconizing” agent in this Comparative Example.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process for molding an article comprising:
applying a permanent release coating to a surface of a mold cavity;
overlaying said permanent release coating with a top coat precursor; and
filling the mold cavity with a polymer or polymer precursor under conditions to form the article and transfer said top coat precursor to form a top coat skin covalently bonded to the article without appreciably removing said permanent release coating from the surface of said mold cavity.

2. The process of claim 1 wherein said permanent release coating is applied as multiple layers.

3. The process of claim 1 wherein said permanent release coating is applied neat.

4. The process of claim 1 wherein said permanent release coating cures prior to overlaying with said top coat precursor.

5. The process of claim 4 wherein cure occurs through mold heating.

6. The process of claim 1 wherein said permanent release coating is applied through spraying.

7. The process of claim 1 wherein said top coat precursor covalently reacts with said polymer or said polymer precursor during molding to form said top coat skin covalently bonded to the article.

8. The process of claim 1 wherein said top coat precursor contains unsaturated moieties.

9. The process of claim 8 wherein the unsaturated moieties are covalently bonded to silicon by a covalent bond with a carbon atom.

10. The process of claim 1 wherein said top coat precursor is a silicon based polymer.

11. The process of claim 10 wherein said slime polymer is fluorinated.

12. The process of claim 1 wherein said top coat precursor is a hydride functional silicon polymer.

13. The process of claim 1 wherein said top coat skin is fluorinated or perfluorinated.

14. An elastomeric molded article comprising:
a molded body having a plurality of surfaces; and
a top coat skin covalently bonded uniformly to the plurality of surfaces.

15. The article of claim 14 wherein said body is formed as an elastomeric stopper.

16. The article of claim 14 wherein said body is formed of halobutyl elastomer.

17. The process of claim 14 wherein said top coat skin is formed from a coating which contains unsaturated moieties.
